(19) United States
(12) Patent Application Publication
(10) Pub. No.: US 2010/0053188 A1
(43) Pub. Date: Mar. 4, 2010

(54) DIGITAL PHOTO FRAME CAPABLE OF ADJUSTING DIGITAL IMAGE AND METHOD THEREOF

(75) Inventors: Ming-Feng Tsai, Tu-Cheng (TW); Te-Yuan Kung, Tu-Cheng (TW); Cheng-Hao Chou, Tu-Cheng (TW); Xiao-Guang Li, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/344,579

(22) Filed: Dec. 28, 2008

(30) Foreign Application Priority Data
Aug. 29, 2008 (CN) 200810304308.X

(51) Int. Cl. G09G 5/00

(52) U.S. Cl. 345/581

(57) ABSTRACT

A method for adjusting digital image is provided. The method includes: acquiring a predetermined time interval; receiving input signals; generates control signals according to operations on the button; and adjusting images according to the control signals.

### TECHNICAL FIELD

The disclosure relates to a digital photo frame for adjusting digital images and method employed by the digital photo frame to adjust the images.

### DESCRIPTION OF RELATED ART

Digital photo frames are intended to conveniently display digital images without the need to print the digital images out. Currently, some digital photo frames have only simple input units, for example, a few of buttons, and the buttons can only relay a few signals. These digital photo frames are limited to receiving user input just though those simple input units, that is, a user can only perform a few operations, so to adjust how the digital photo frames display an image by those input units can be a complex process. Therefore, what is needed is a digital photo frame allowing simple button operations to adjust image properties.

### BRIEF DESCRIPTION OF THE DRAWINGS

The components of the drawings are not necessarily drawn to scale, the emphasis instead being placed upon clearly illustrating the principles of a digital photo frame. Moreover, in the drawings, like reference numerals designate corresponding parts throughout several views.

FIG. 1 is a block diagram of a digital photo frame in accordance with an exemplary embodiment.

FIG. 2 is a flowchart illustrating a method of adjusting properties of a current image according to user input in the digital photo frame of FIG. 1 in accordance with an exemplary embodiment.

FIG. 3 is a flowchart for a method of cycling through images one at a time, according to an exemplary embodiment, to allow user adjustment of image properties according to user input of the method in FIG. 2.

### DETAILED DESCRIPTION OF EMBODIMENTS

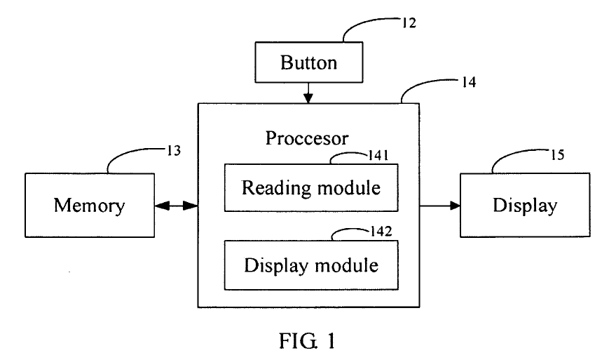

FIG. 1 is a block diagram of a hardware infrastructure of a digital photo frame in accordance with an exemplary embodiment. The digital photo frame includes at least one input interface such as a button 12, a memory 13, a processor 14, and a display 15.

The memory 13 is configured for storing images and a sequence table. Each image is associated with a plurality of image properties, such as brightness, contrast, and the like. The sequence table records an order of adjusting image properties and an order of the values of each image properties. For example, in the exemplary embodiment, the order of adjusting image properties is set as brightness adjustment first, and then contrast adjustment second. The memory 13 further stores different values of each image property. Additionally, the memory 13 stores a predetermined time interval T1. T1 can be a system default, and also can be user-defined.

When the digital photo frame enters an adjustment mode to adjust an image displayed on the display 15, the digital photo frame obtains a default image property, namely the first image property from the sequence table, and performs an adjustment on the default image property according to user input.

The button 12 is configured for relaying input signals to the processor 14.

The processor 14, being connected with the memory 13 as well as the button 12 and the display 15, is configured for generating control signals in response to various input signals while the button 12 is held pressed down. In an exemplary embodiment, for example, when the duration that the button 12 is held down is T>T1, the processor 14 generates a skipping control signal; when the duration that the button is held down is T<T1, the processor 14 generates a switching control signal; when the button 12 is double clicked, the processor 14 generates a selecting control signal.

The processor 14 includes a reading module 141 and a display module 142. The reading module 141 is configured for obtaining images and the sequence table from the memory 13. The display module 142 is configured for adjusting properties of the image according to the sequence table and control signals that generated by the processor 14.

The display module 142 performs property adjustment for the current image, wherein the current image property described above and below is a image property that the display module 142 currently adjusts. When the processor 14 generates the skipping control signal, the display module 142 directly adjusts an image property next to the current image property (hereinafter, “the next image property”); when the processor 14 generates the switching control signal, the display module 142 switches between various values of the current image properties, and displays the image with various values of the current image properties; when the processor 14 generates the selecting control signal, the display module 142 selects a value of the current image property, and adjusts the next image property based on the image with the selected value of the current image property.

For better understanding of the present disclosure, an exemplary adjustment embodiment is illustrated hereinafter. For example, the display module 142 currently performs brightness adjustment, the values of brightness include darkest, darker, brighter, and brightest, the image property next to brightness is contrast, and the values of contrast include 20%, 40%, 60%, and 80%.

If there is new input signals, the processor 14 generates control signals in response to the new input signals. When the processor 14 generates the skipping control signal, the display module 142 skips the adjustment for brightness, and directly enters the adjustment for contrast.

When the processor 14 generates a switching control signal, the display module 142 switches between various values of brightness. For example, the display module 142 currently displays the image in darker brightness, if the processor 14 generates a second switching control signal, the display module 142 displays the image in further darkness. Therefore, when the processor 14 generates severer switching control signals continually, the display module 142 circularly displays the image in various values of brightness.

When the processor 14 generates the selecting control signal, the display module 143 selects one of the values of brightness, for example, a brighter value, that is, the display module 142 determines to adjust brightness of the image to be brighter, then the display module 142 enters to adjust contrast based on the display effect of the image in the brighter value.

The digital photo frame can provide a menu item for activating the digital photo frame to enter the image property adjustment mode.

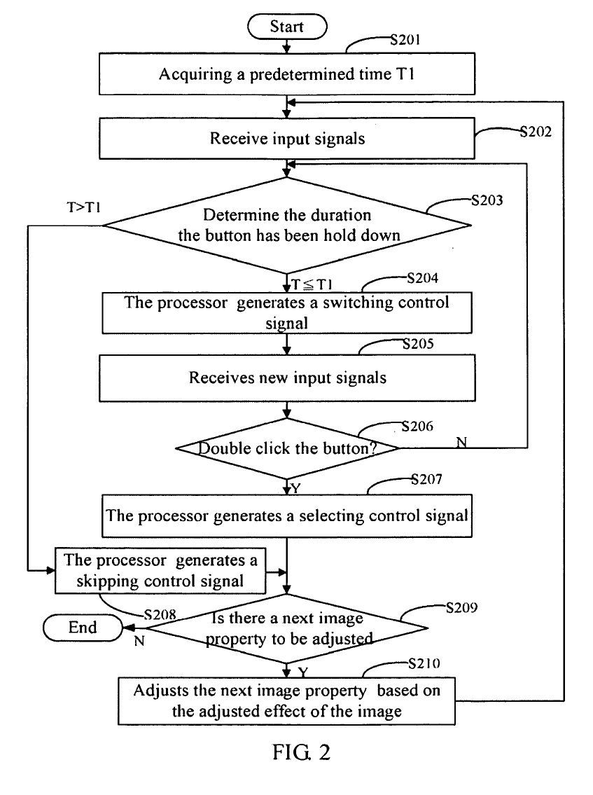

FIG. 2 is a flowchart illustrating a method of adjusting properties of a current image according to user input in the digital photo frame of FIG. 1 in accordance with an exemplary embodiment.

In step S201, after the digital photo frame invokes the image property adjustment mode though the menu item, the reading module 141 acquires the predetermined time T1 and a sequence table, and the display module 142 adjusts the default image property.

In step S202, the processor 14 receives the input signals corresponding to operations on the button.

In step S203, the display module 142 determines the duration T that the button 12 is held down.

If the duration is T>T1, the processor 14 generates the skipping control signal, and the procedure goes to S208.

In the step S204, if the duration is T≦T1, the processor 14 generates the switching control signal, the display module 142 switches from a value of the current image property to another value thereof, and displays the image with various values of the current image property.

In step S205, the processor receives new input signals.

In step S206, the processor 14 determines whether the button 12 is double clicked according to the input signals. If the button 12 is not double clicked, the procedure returns to S203.

In step S207, if the button 12 is double clicked, the processor 14 generates the selecting control signal, and the display module 142 selects a value of the current image property, and the adjustment of the current image property is finished, and step S209 is performed next.

In step S209, the display module 142 determines whether there is a next image property to be adjusted. If there is no next image property, the procedure ends.

In step S210, if there is a next image property, the display module 142 regards the next image property as the current image property, and adjusts the current image property based on the display effect of the previous image property, the procedure returns to step 202.

Additionally, when adjusting one of the image properties, the display module 142 displays information of the current image property. For example, the information may include, but is not limited to, a name, values of the current image property. The display module 142 can also displays a name of the next image property according to the sequence table.

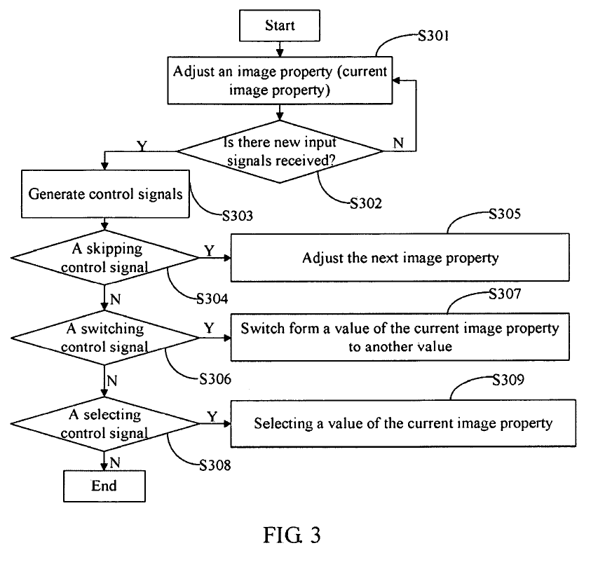

For the purpose of easy understanding, a flowchart for a method of cycling through images one at a time to allow user adjustment of image properties is illustrated in FIG. 3.

In step S301, the display module 142 performs an image property adjustment (the current image property adjustment).

In step S302, the processor 14 determines whether there is new input signals received, if there is no, the procedure return to step 301; if there is new inputs signal received, the procedure goes to step S303.

In step S303, the processor generates control signals corresponding to the input signals.

In step S304, if the control signal is a skipping control signal, the procedure goes to S305.

In step S305, the display module 142 directly adjusts the next image property. That is, in such condition, the display module 142 skips the adjustment on the current image property.

In step S306, if the control signal is a switching control signal, the procedure goes to step S307.

In step S307, the display module 142 switches between various values of the current image property, at the same time, the display module 142 displays the image according to various values.

In step S308, if the control signal is a selecting control signal, the procedure goes to step S309.

In step S309, the display module 142 selects a value of the current image property, and the adjustment of the current image property is finished.

Furthermore, if there exists a next image property to be adjusted, the display module 142 adjusts the next image parameter based on the display effect that is selected before. When the display module 142 completes the last image property adjustment, the display effect of the image is the final adjustment effect.

Although the present invention has been specifically described on the basis of the exemplary embodiment thereof, the invention is not to be construed as being limited thereto. Various changes or modifications may be made to the embodiment without departing from the scope and spirit of the invention.

What is claimed is:

1. A digital photo frame (DPF) for adjusting images, comprising:
a button for relaying input signals;
a memory for storing images, a sequence table, and various values of properties of each image, wherein each of the images is associated with a plurality of image properties, and the sequence table records an order of adjusting image properties and an order of showing the values of each image property; and
a processor, being connected with the memory as well as the button and the display, for adjusting image values and generating control signals according to input signals, wherein the control signals includes a skipping control signal, a switching control signal, and a selecting control signal, the processor comprising:
a reading module configured for obtaining the images and the sequence table from the memory; and
a display module configured for adjusting the image properties according to the control signals and the sequence table, wherein upon the condition that the processor generates the skipping control signal, the display module directly adjusts an image property next to the current image property (next image property); upon the condition that the processor generates the switching control signal, the display module switches between various values of the current image property, and displays the image with various values of the current image property; and upon the condition that the processor generates the selecting control signal, the display module selects a value of the current image property, and adjusts the next image property based on the image with the selected value of the current image property.

2. The DPF as described in claim 1, wherein the memory stores a predetermined time T1, when the duration that the button is held down is T>T1, the processor generates the skipping control signal; when the duration is T≦T1, the processor generates the switching control signal; when the button is double clicked, the processor generates the selecting control signal.

3. The DPF as described in claim 1, wherein the sequence table is pre-set, or defined by a user.

4. The DPF as described in claim 1, wherein the display module is further configured to control a display of the DPF to display information of the current image property and information of the next image property, wherein the information includes at least a name, and a value.

5. A method of adjusting image properties applied on a digital photo frame (DPF) which includes:
a button;
a memory; and
a display,
the method comprising:
acquiring a predetermined time interval T1;
receiving input signals;
generating control signals corresponding to the input signals;
upon the condition that the processor generates a skipping control signal, directly adjusting the image property next to the current image property according to the sequence table;
upon the condition that the processor generates a switching control signal, switching between different values of the current image property, and displays corresponding display effects of the image with different values of the current image property;
upon the condition that the processor generates a selecting control signal, selecting a display effect of the image, and adjusting the image property next to the current image property based on the selected display effect of the image.

6. The method as described in claim 5, wherein the processor generates control signals according to operations on the button upon the condition that the duration T that the button is held down is T>T1, the processor generates a skipping control signal; upon the condition that the duration is T≦T1, the processor generates a switching control signal; upon the condition that the button is double clicked, the processor generates a selecting control signal.

7. The method as described in claim 5, further comprising: obtaining a sequence table from the memory, wherein the sequence table records an order of adjusting image properties and an order of different values of each image property, the default image property is the first image property recorded in the sequence table.

8. The method as described in claim 5, when adjusting a image property, displaying information of the current image property and information on next image property, the information comprises a name and a value.
